(19) United States
(12) Patent Application Publication
(10) Pub. No.: US 2026/0364611 A1
(43) Pub. Date: Nov. 19, 2026

(54) HORIZONTAL DECANTER CENTRIFUGE WITH MULTI-WHEEL ADJUSTABLE CENTRIPETAL PUMP ASSEMBLY

(71) Applicant: SUZHOU UNITED MACHINE CO., LTD, Jiangsu (CN)

(72) Inventor: Ren Jianmin, Jiangsu (CN)

(73) Assignee: FLUIDQUIP KS, LLC, Springfield, OH (US)

(21) Appl. No.: 19/675,782

(22) Filed: May 13, 2026

(30) Foreign Application Priority Data
May 16, 2025 (CN) 202520965894.1

(51) Int. Cl. B04B 1/20; B04B 7/08

(52) U.S. Cl. CPC B04B 1/2016; B04B 7/08; B04B 2001/2083; B04B 2001/2091

(57) ABSTRACT

A centripetal pump assembly for a horizontal decanter centrifuge provides adjustable liquid pool depth using a plurality of rotatable pump wheels. Each pump wheel defines a suction port and is rotatably mounted within a stationary pump body via a wheel shaft. A drive assembly, comprising a large gear on the feed pipe meshing with small gears on the wheel shafts, simultaneously rotates all pump wheels to change the radial positions of the suction ports within the rotating bowl. The multiple symmetrically arranged pump wheels provide high flow capacity for large centrifuges while distributing hydraulic forces evenly to reduce vibration. An arcuate internal flow channel within each pump wheel facilitates liquid transfer from the suction port to a central discharge chamber. The pool depth can be adjusted during operation without shutdown.

### RELATED APPLICATIONS

This application claims priority to and benefit of prior Chinese Patent Application No. 202520965894.1 filed on May 16, 2025, the contents of which are hereby incorporated by reference herein in their entirety for all purposes.

### FIELD

The present invention relates generally to centrifugal separation equipment, and more particularly to a centripetal pump assembly for a horizontal decanter centrifuge that provides adjustable liquid pool depth through a plurality of rotatable pump wheels.

### BACKGROUND

Horizontal decanter centrifuges are widely used in industrial processes to separate mixtures of solids and liquids based on density differences. A typical decanter centrifuge comprises a rotating cylindrical-conical bowl and an internal helical scroll conveyor rotating at a differential speed. During operation, feed material enters the rotating bowl through a feed pipe and stratifies radially under centrifugal force, with the heaviest solids accumulating at the bowl wall and liquids forming inner layers. The scroll conveyor continuously transports separated solids toward a discharge port at the conical end, while clarified liquids are discharged through separate channels at the opposite end.

The two principal methods of liquid discharge in decanter centrifuges are overflow discharge and pressure discharge. In overflow-type centrifuges, the separated liquid overflows from an overflow port at the large end of the bowl, collects inside a housing, and flows out of the centrifuge under atmospheric conditions. In pressure-discharge centrifuges, a centripetal pump installed within the rotating bowl directly pumps the separated liquid out of the centrifuge under pressure. The centripetal pump operates by immersing a suction port of a pump wheel into the liquid layer rotating at high speed inside the bowl; the liquid relies on the kinetic energy of the rotating bowl contents to enter the pump body and be transported out through a stationary discharge passage.

Centripetal pumps for decanter centrifuges are generally classified as fixed or adjustable. Fixed centripetal pumps employ pump wheels having multiple suction ports arranged at a constant radial diameter. Because the suction port diameter is fixed, the liquid pool depth (defined as the radial distance between the bowl wall and the free liquid surface) is not adjustable during operation. To change the liquid pool depth, the pump wheel must be physically replaced with one having a different diameter, requiring shutdown and disassembly. Although fixed centripetal pumps can accommodate high flow rates by virtue of their multiple suction ports, the inability to adjust pool depth during operation limits their utility in processes where feed composition varies over time.

Adjustable centripetal pumps address this limitation by providing a mechanism for changing the effective radial position of the suction port during operation. In a conventional adjustable centripetal pump, a single pump wheel having a single suction port is mounted eccentrically on a shaft. By rotating the pump wheel about the shaft axis, the radial position of the single suction port changes relative to the rotational axis of the bowl, thereby adjusting the pool depth. However, this approach suffers from at least two significant drawbacks.

First, because the adjustable pump wheel has only a single suction port, the liquid discharge capacity is limited. A single-suction-port pump (also referred to as an impeller) is generally adequate only for small to medium-sized centrifuges having single-unit processing capacities of less than approximately 20 cubic meters per hour (e.g., approximately less than 90 gallons per minute). For large-sized centrifuges requiring higher throughput, a single suction port cannot provide sufficient drainage flow.

Second, the single-suction-port configuration produces unbalanced forces on the pump body. When the single suction port cuts into the high-speed rotating liquid layer, the resulting hydraulic impact acts on only one side of the pump body. This asymmetric loading produces severe vibration of the pump body, and the feed pipe that is mechanically coupled to the centripetal pump is prone to fatigue failure due to the cyclic vibration loading. The unbalanced forces also reduce the service life of bearings and seals associated with the pump assembly.

There accordingly remains a need in the art for a centripetal pump assembly for a horizontal decanter centrifuge that provides adjustable liquid pool depth while also accommodating the high-flow drainage requirements of large-sized centrifuges, and that distributes hydraulic loading symmetrically across the pump body to reduce vibration and improve reliability.

### SUMMARY

Embodiments of the present invention address the limitations of prior centripetal pump designs by providing an adjustable centripetal pump assembly having a plurality of rotatable pump wheels, each provided with a respective suction port, mounted within a stationary pump body. A drive assembly mechanically couples the pump wheels to a rotational input and simultaneously rotates all pump wheels to change the radial positions of their respective suction ports within the rotating bowl, thereby adjusting the liquid pool depth during operation.

In some embodiments, a horizontal decanter centrifuge is provided comprising a rotary bowl, a feed pipe extending into the rotary bowl, a helical scroll conveyor disposed within the rotary bowl, and a centripetal pump assembly installed at a liquid discharge end of the rotary bowl. The centripetal pump assembly comprises a stationary pump body fixedly mounted relative to the rotary bowl, the pump body defining a plurality of clearance slots. A plurality of pump wheels is rotatably received within respective clearance slots of the pump body, each pump wheel being provided with a suction port and being rotatably connected to the pump body via a respective wheel shaft. A drive assembly is mechanically coupled to the plurality of wheel shafts and is configured to simultaneously rotate the pump wheels to change the radial positions of the suction ports within the rotary bowl.

In some embodiments, the drive assembly comprises a large gear fixedly connected to the feed pipe and a plurality of small gears, each small gear being fixedly connected to a respective wheel shaft. The large gear meshes with the plurality of small gears such that rotation of the feed pipe about its longitudinal axis causes simultaneous rotation of all pump wheels. A driving device, which may be an electric motor or a manual device, is coupled to the feed pipe to provide the rotational input.

In some embodiments, each pump wheel defines an internal liquid inlet flow channel having a first end in fluid communication with the respective suction port and a second end in fluid communication with a discharge chamber defined within the pump body. The liquid inlet flow channel may be arcuate, and the inner diameter of the liquid inlet flow channel may gradually increase in a direction toward the feed pipe to facilitate liquid ingress.

In some embodiments, a drainage channel is provided between the pump body and the feed pipe, the drainage channel being in fluid communication with the discharge chamber and terminating at a liquid outlet external to the rotary bowl.

The provision of multiple rotatable pump wheels provides several advantages over prior designs. The plurality of suction ports collectively provides sufficient flow capacity for large-sized centrifuges having processing capacities exceeding 20 cubic meters per hour (equivalent to approximately 90 gallons per minute or more). The symmetrical arrangement of multiple pump wheels distributes hydraulic loading evenly around the pump body, substantially reducing vibration and improving reliability and service life. The simultaneous rotation of all pump wheels through the gear drive provides precise and repeatable adjustment of the liquid pool depth during operation, without requiring shutdown or disassembly.

### BRIEF DESCRIPTION OF THE DRAWINGS

The invention will be better understood from the following detailed description of preferred embodiments, taken in conjunction with the accompanying drawings, in which:

FIG. 1 is a longitudinal cross-sectional view of a horizontal decanter centrifuge incorporating a centripetal pump assembly pursuant to some embodiments.

FIG. 2 is an enlarged cross-sectional view showing the installation of the feed pipe, pump body, and drive assembly pursuant to some embodiments.

FIG. 3 is a transverse cross-sectional view of the pump body showing the arrangement of pump wheels and the discharge chamber pursuant to some embodiments.

FIG. 4 is a transverse cross-sectional view showing the pump wheels oriented at a minimum liquid pool depth position pursuant to some embodiments.

FIG. 5 is a transverse cross-sectional view showing the pump wheels oriented at a maximum liquid pool depth position pursuant to some embodiments.

FIG. 6 is a longitudinal cross-sectional view of a prior art overflow-type decanter centrifuge.

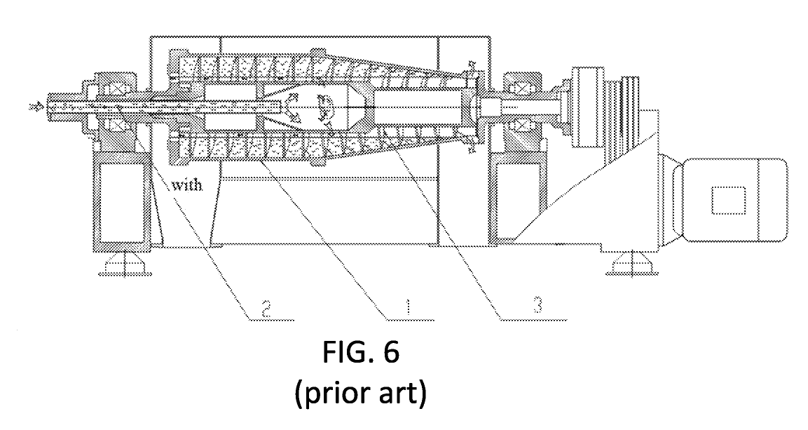

FIG. 7 is a longitudinal cross-sectional view of a prior art decanter centrifuge equipped with a conventional centripetal pump.

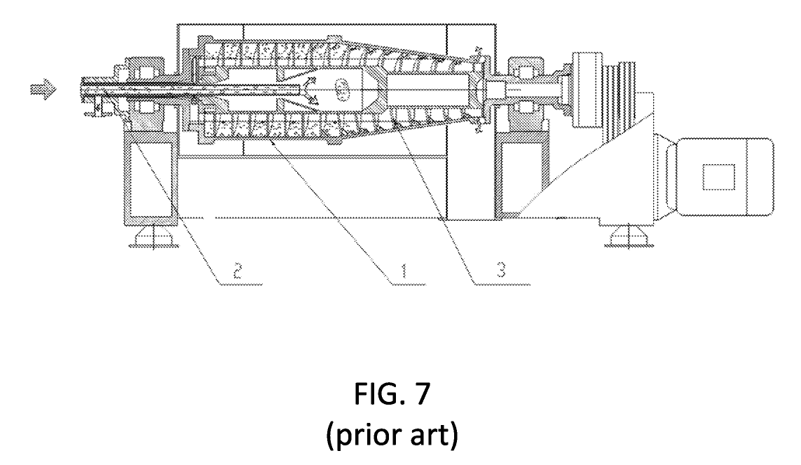

### DETAILED DESCRIPTION

The present invention will now be described in detail with reference to the accompanying drawings. It will be understood that the following description is exemplary and not limiting, and that various modifications and variations may be made without departing from the scope of the invention as defined by the appended claims. Like reference numerals refer to like elements throughout the drawings.

### General Centrifuge Structure

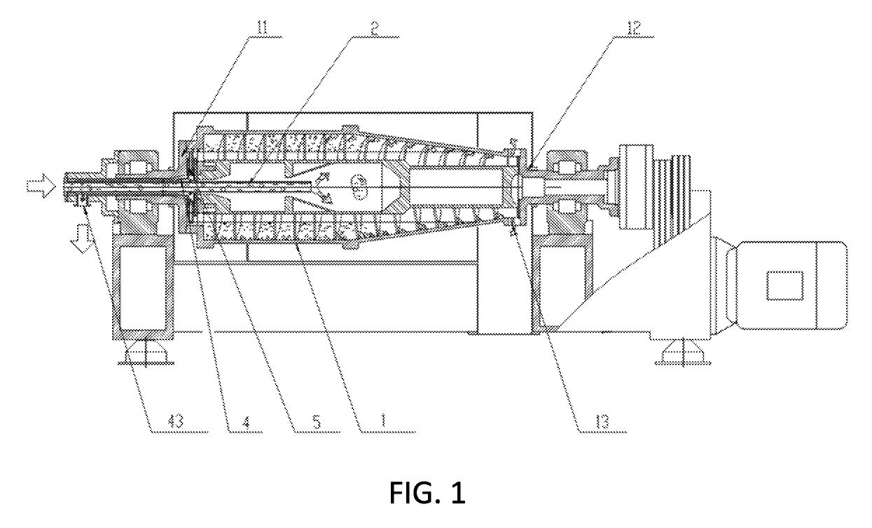

Referring to FIG. 1, a horizontal decanter centrifuge system incorporating a centripetal pump assembly is illustrated, designated generally at 100. The system comprises a rotary bowl 1 mounted for high-speed rotation about its longitudinal axis. The rotary bowl 1 is generally cylindrical along most of its length and may transition to a conical section at one end. The rotary bowl 1 is driven by one or more electric motors (not shown) and is supported by bearings and seals. A protective shell or housing encloses the outer side of the rotary bowl 1.

A helical scroll conveyor 3 (also referred to as a spiral conveyor or screw conveyor) is disposed concentrically within the rotary bowl 1. The scroll conveyor 3 rotates at a differential speed relative to the rotary bowl 1, typically driven by a gearbox that causes the scroll conveyor 3 to rotate slightly slower than the rotary bowl 1. This differential rotation causes the scroll conveyor 3 to advance separated solids along the interior of the rotary bowl 1 toward a solids discharge.

A feed pipe 2 extends axially into the interior of the rotary bowl 1 and delivers a multiphase feed material into the rotating environment. The feed pipe 2 may deliver the feed into a feed zone or distributor within the hollow shaft of the scroll conveyor 3, from which the feed passes through distribution openings into the annular space between the scroll conveyor 3 and the inner wall of the rotary bowl 1.

Both ends of the rotary bowl 1 are equipped with end caps. A large end cap 11 is disposed at the liquid discharge end of the rotary bowl 1, and a small end cap 12 is disposed at the opposite end. The small end cap 12 is provided with a slag outlet 13 (also referred to as a solids discharge port) through which separated solid residue is expelled from the centrifuge. In some embodiments, the conical section of the rotary bowl 1 is adjacent to the small end cap 12, and solids undergo additional dewatering as they are conveyed through the conical section toward the slag outlet 13.

During operation, the multiphase feed enters the rotary bowl 1 through the feed pipe 2 and, under the influence of centrifugal force (which may be several thousand times the force of gravity), stratifies radially according to the densities of its constituent phases. The solid phase, being the densest, accumulates as a layer against the inner wall of the rotary bowl 1. The liquid phase forms an inner layer radially inward of the solid phase. In applications involving multiple liquid phases (e.g., an aqueous phase and a lighter-than-water organic phase), the liquid phases further stratify into distinct radial zones based on their respective densities.

The scroll conveyor 3 continuously transports the separated solid phase along the length of the rotary bowl 1 toward the slag outlet 13. After collection in a solid residue collection chamber, the solids are discharged from a residue hopper out of the machine. The separated liquid phase flows toward the large end cap 11 for discharge through the centripetal pump assembly, as described below.

### Centripetal Pump Assembly

Referring now to FIGS. 1-3, the centripetal pump assembly is installed inside the rotary bowl 1 at the large end cap 11 and comprises a pump body 4, a plurality of pump wheels 5, a plurality of wheel shafts 6, and a drive assembly.

The pump body 4 is a stationary component that is fixedly connected to a support frame at one end of the centrifuge. Importantly, the pump body 4 does not rotate during operation of the centrifuge; it remains stationary while the rotary bowl 1 and the liquid pool within it rotate at high speed around the pump body 4. The pump body 4 is positioned within the interior of the rotary bowl 1 at the large end cap 11.

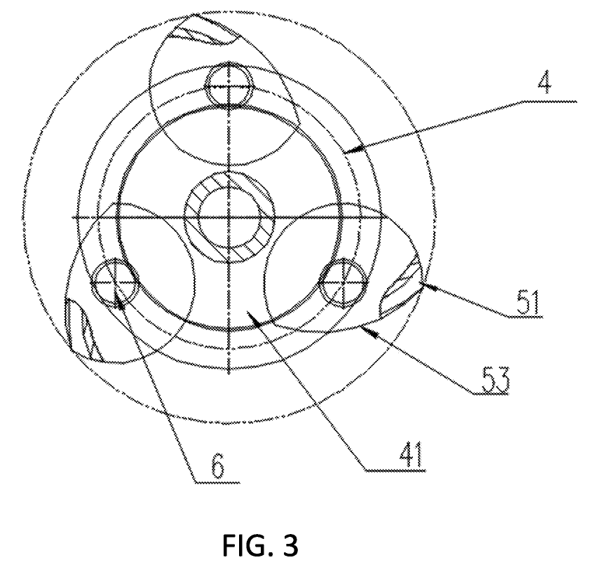

As best seen in FIG. 3, the pump body 4 defines a central discharge chamber 41 and a plurality of clearance slots arranged circumferentially around the discharge chamber 41. In the illustrated embodiment, three clearance slots are provided at approximately 120-degree intervals, though two, four, or more clearance slots may be provided in other embodiments. The clearance slots are sized to receive respective pump wheels 5 with sufficient clearance to allow rotational movement.

Each pump wheel 5 is received within a respective clearance slot of the pump body 4 and is rotatably connected to the pump body 4 via a respective wheel shaft 6. The wheel shaft 6 passes through the pump body 4 and is rotatably supported therein, for example by bearings or bushings. Each pump wheel 5 is fixedly connected to its respective wheel shaft 6, for example by an interference fit between the inner bore of the pump wheel 5 and the wheel shaft 6, such that rotation of the wheel shaft 6 causes corresponding rotation of the pump wheel 5.

Each pump wheel 5 is provided with a suction port 51. The suction port 51 is an opening at the outer periphery of the pump wheel 5 through which liquid from the rotating pool within the rotary bowl 1 is drawn into the pump wheel 5. When the suction port 51 is immersed in the liquid layer rotating at high speed inside the rotary bowl 1, the kinetic energy of the rotating liquid drives the liquid into the suction port 51 and through the internal passages of the pump wheel 5.

In the illustrated embodiment, the number of pump wheels 5 is three, providing three suction ports 51 distributed symmetrically around the pump body 4. This symmetric arrangement ensures that the hydraulic forces acting on the pump body 4 when the suction ports 51 cut into the rotating liquid layer are substantially balanced, significantly reducing vibration compared to single-suction-port designs. In other embodiments, two pump wheels, four pump wheels, or more may be employed. In all cases, the use of two or more pump wheels provides improved force balance relative to a single pump wheel.

### Internal Flow Channels

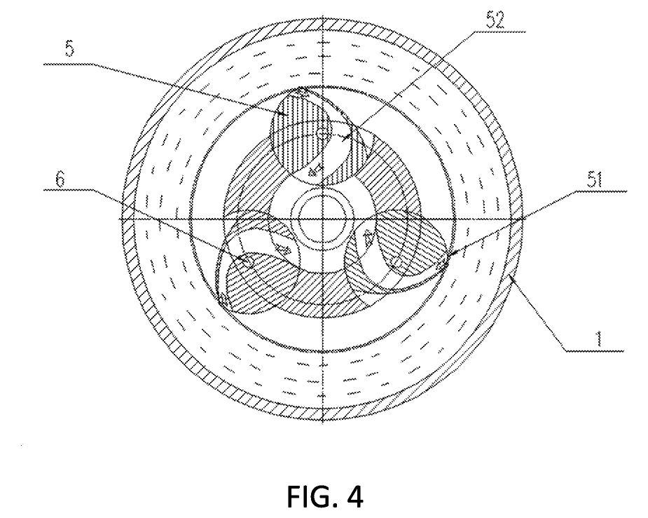

Referring still to FIGS. 3 and 4, each pump wheel 5 defines an internal liquid inlet flow channel 52. The liquid inlet flow channel 52 extends from the suction port 51 at the outer periphery of the pump wheel 5 to the discharge chamber 41 within the pump body 4. Thus, one end of the liquid inlet flow channel 52 is in fluid communication with the suction port 51, and the other end is in fluid communication with the discharge chamber 41.

In some embodiments, the liquid inlet flow channel 52 is arcuate (i.e., curved). The arcuate geometry facilitates smooth flow of liquid through the pump wheel 5 by reducing sudden changes in flow direction that might otherwise create turbulence or flow resistance. The curved path also takes advantage of the Coriolis effect and the centripetal acceleration of the liquid to promote efficient transfer from the suction port 51 to the discharge chamber 41.

In some embodiments, the inner diameter of the liquid inlet flow channel 52 gradually increases in a direction toward the feed pipe 2 (i.e., toward the center of the pump body 4 and the discharge chamber 41). This tapering configuration accommodates the decreasing velocity and increasing pressure of the liquid as it moves radially inward, facilitating rapid entry of liquid into the pump wheel 5 and reducing cavitation.

### Pump Wheel Geometry

In some embodiments, as shown in FIGS. 3-5, each pump wheel 5 has an overall circular cross-section with an arc-shaped transition surface 53 on the upper side (i.e., the side facing the inner wall of the rotary bowl 1). The arc-shaped transition surface 53 reduces the overall volume of the pump wheel 5 and provides a streamlined profile that decreases hydrodynamic resistance as the rotating liquid flows past the pump wheel 5. This reduction in resistance contributes to energy efficiency and reduces heating of the liquid.

### Drive Assembly

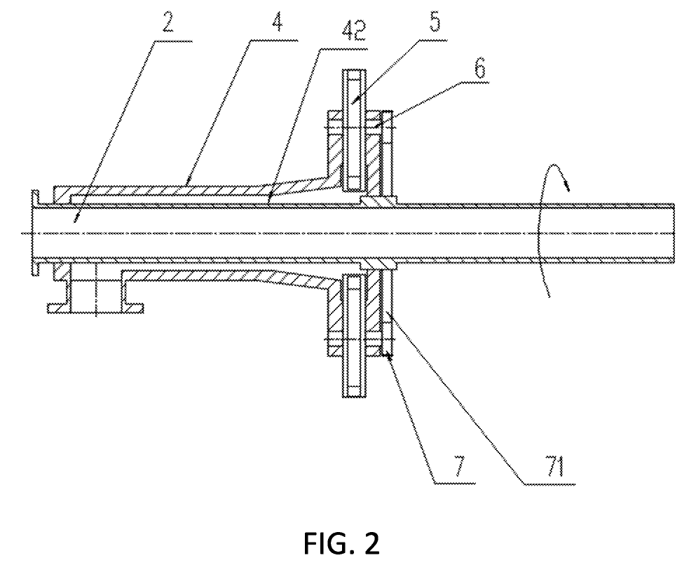

Referring now to FIG. 2, the drive assembly for rotating the pump wheels 5 is illustrated. The drive assembly comprises a large gear 71 and a plurality of small gears 7. Each small gear 7 is fixedly connected to a respective wheel shaft 6, for example by welding, keyed engagement, or other permanent or semi-permanent attachment. The large gear 71 is fixedly connected to the feed pipe 2.

The small gears 7 are disposed on one side of the pump body 4, with a gap maintained between each small gear 7 and the adjacent face of the pump body 4 to permit free rotation. The large gear 71 meshes with each of the small gears 7. Thus, when the large gear 71 rotates, it simultaneously drives all of the small gears 7, which in turn rotate the respective wheel shafts 6 and the pump wheels 5 attached thereto.

Because the large gear 71 is fixedly connected to the feed pipe 2, rotation of the feed pipe 2 about the stationary pump body axis causes the large gear 71 to rotate and, through the meshing engagement with the small gears 7, causes simultaneous rotation of all pump wheels 5. The gear ratio between the large gear 71 and each small gear 7 determines the angular displacement of each pump wheel 5 for a given angular rotation of the feed pipe 2. In some embodiments, the gear ratio is selected such that a full rotation of the feed pipe 2 produces a partial rotation of the pump wheels 5 corresponding to the full range of liquid pool depth adjustment.

The drive assembly further comprises a driving device for rotating the feed pipe 2. In some embodiments, the driving device is an electric motor, such as a servo motor or stepper motor, coupled to one end of the feed pipe 2, external to the rotary bowl 1. In other embodiments, the driving device is a manual device such as a hand wheel, lever, or worm gear mechanism. In some embodiments, the driving device may be operated while the centrifuge is running at full rotational speed, allowing on-the-fly adjustment of the liquid pool depth without requiring shutdown.

To accommodate rotation of the feed pipe 2 relative to the stationary pump body 4, the feed pipe 2 is mounted on bearings or other rotational support elements that permit the feed pipe 2 to rotate about the longitudinal axis of the pump body 4 while maintaining the feed-through capability of the pipe.

### Drainage Channel and Liquid Outlet

Referring again to FIGS. 1 and 2, a drainage channel 42 is provided between the pump body 4 and the feed pipe 2. The drainage channel 42 is in fluid communication with the discharge chamber 41 of the pump body 4 and terminates at a liquid outlet 43 that is external to the rotary bowl 1. During operation, liquid that enters the pump wheels 5 through the suction ports 51 passes through the respective liquid inlet flow channels 52, enters the discharge chamber 41, flows through the drainage channel 42, and exits the centrifuge through the liquid outlet 43 under pressure.

### Pool Depth Adjustment Operation

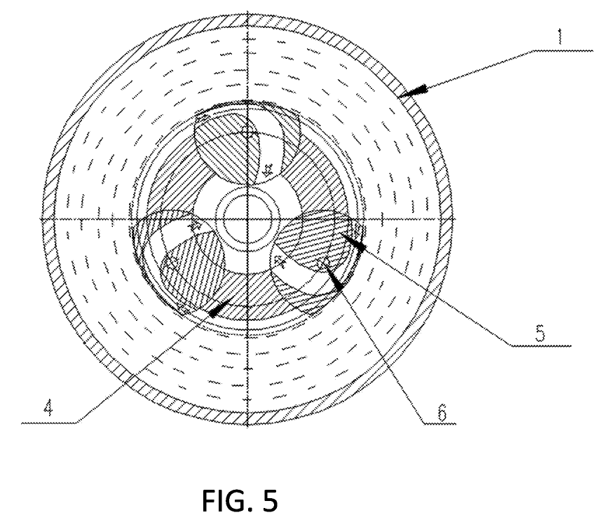

Referring now to FIGS. 4 and 5, the operation of the pump assembly for adjusting the liquid pool depth is illustrated. FIG. 4 shows the pump wheels 5 oriented in a position corresponding to a minimum liquid pool depth, and FIG. 5 shows the pump wheels 5 oriented in a position corresponding to a maximum liquid pool depth.

Because each pump wheel 5 is mounted eccentrically on its respective wheel shaft 6, rotation of the pump wheel 5 about the wheel shaft axis changes the radial position of the suction port 51 relative to the rotational axis of the rotary bowl 1. When the pump wheels 5 are oriented as shown in FIG. 4, the suction ports 51 are positioned at a maximum radial distance from the rotational axis, resulting in a shallow liquid pool (minimum pool depth). When the pump wheels 5 are rotated to the orientation shown in FIG. 5, the suction ports 51 are positioned at a reduced radial distance from the rotational axis, resulting in a deeper liquid pool (maximum pool depth).

The simultaneous rotation of all pump wheels 5 through the gear drive assembly ensures that all suction ports 51 move in concert, maintaining the symmetric distribution of suction ports around the pump body 4 at all adjustment positions. This preserves the balanced-force advantage throughout the full range of pool depth adjustment.

The liquid pool depth can be adjusted continuously between the minimum and maximum positions by rotating the feed pipe 2 through an appropriate angle via the driving device. The resolution of the adjustment depends on the gear ratio and the precision of the driving device. In embodiments employing an electric servo or stepper motor, sub-millimeter precision in pool depth adjustment can be achieved.

### Process of Operation

During operation of the centrifuge, raw slurry or other multiphase feed material enters the centrifuge through a feed inlet and the feed pipe 2, passes into the hollow shaft of the scroll conveyor 3, and enters the rotary bowl 1 through distribution openings. Under centrifugal force, the feed stratifies into a solid phase accumulating at the inner wall of the rotary bowl 1 and a liquid phase occupying the radially inward region.

The separated liquid flows toward the large end cap 11 where the centripetal pump assembly is installed. The suction ports 51 of the pump wheels 5 are immersed in the rotating liquid layer at a radial position determined by the current angular orientation of the pump wheels 5. The rotating liquid enters the suction ports 51, passes through the liquid inlet flow channels 52 within the pump wheels 5, enters the discharge chamber 41 of the stationary pump body 4, flows through the drainage channel 42, and exits through the liquid outlet 43 under pressure generated by the kinetic energy of the rotating liquid.

Meanwhile, the solid phase is continuously conveyed by the scroll conveyor 3 toward the small end cap 12 and exits through the slag outlet 13, achieving continuous separation of solid and liquid phases.

When the operator or an automated control system determines that the liquid pool depth should be adjusted (for example, in response to changes in feed composition, temperature, flow rate, or desired separation performance), the driving device is actuated to rotate the feed pipe 2. This rotation is transmitted through the large gear 71 and the small gears 7 to the pump wheels 5, changing the radial position of the suction ports 51 and thereby adjusting the liquid pool depth. The adjustment can be performed while the centrifuge is operating at full speed, without interrupting the separation process.

### Alternative Embodiments

While the foregoing description focuses on a preferred embodiment employing three pump wheels driven by a gear assembly connected to the feed pipe, it will be understood that numerous variations and modifications are possible within the scope of the invention.

In alternative embodiments, the number of pump wheels may be two, four, five, six, or more. In general, the number of pump wheels is selected to provide the desired flow capacity and degree of force balance for the particular centrifuge size and application.

In alternative embodiments, the drive assembly may employ different power transmission mechanisms in place of or in addition to the gear drive. For example, the drive assembly may employ a chain-and-sprocket arrangement, a belt-and-pulley system, a worm gear mechanism, a planetary gear set, or a direct-drive configuration in which individual servo motors are coupled to respective wheel shafts. In some embodiments, the drive assembly may include a differential mechanism that provides different angular displacements to different pump wheels, although equal angular displacement (as in the preferred embodiment) provides the best force balance.

In alternative embodiments, the feed pipe need not serve as the rotational input to the drive assembly. Instead, a separate drive shaft concentric with or parallel to the feed pipe may provide the rotational input. This arrangement decouples the pool depth adjustment function from the feed delivery function, which may be advantageous in applications where the feed pipe must remain rotationally stationary.

In alternative embodiments, the liquid inlet flow channel within each pump wheel may have a straight, helical, or other non-arcuate geometry. The cross-sectional shape of the flow channel may be circular, elliptical, rectangular, or other shapes depending on manufacturing and fluid-dynamic considerations.

In alternative embodiments, the centripetal pump assembly may be used in two-phase separation (solid-liquid) or three-phase separation (solid-liquid-liquid) applications. In three-phase applications, the pump assembly may be used to control the interface between the two liquid phases by adjusting the pool depth.

In some embodiments, the centripetal pump assembly may be combined with an automated control system comprising one or more sensors configured to monitor properties of the liquid discharge (such as turbidity, water content, or phase purity) and a controller programmed to automatically adjust the angular position of the pump wheels based on sensor feedback. Such a control system may employ proportional-integral-derivative (PID) control, fuzzy logic, or machine-learning algorithms to optimize separation performance in real time.

In some embodiments, position sensors or encoders may be associated with the wheel shafts or the feed pipe to provide real-time feedback of the angular position of the pump wheels, enabling precise closed-loop control of the pool depth setting.

In some embodiments, the pump body may be provided with sealing elements such as O-rings, labyrinth seals, or mechanical face seals at the interfaces between the pump wheels and the pump body to reduce leakage between the suction side and the discharge side of the pump assembly.

Those skilled in the art will appreciate that various modifications and improvements can be made without departing from the inventive concept, and all such modifications fall within the protection scope of the invention as defined by the appended claims.

What is claimed is:

1. A horizontal screw centrifuge, comprising:
a rotary bowl having a centripetal pump assembly installed therein;
a feed pipe; and
a spiral conveyor, wherein the spiral conveyor is arranged inside the rotary bowl;
wherein the centripetal pump assembly includes a pump body having a plurality of pump wheels, each of the plurality of pump wheels having a suction port and each of the plurality of pump wheels connected to the pump body via a wheel shaft such that the drive assembly drives the rotation of the pump wheel to change the position of the suction port within the rotary bowl.

2. The horizontal screw centrifuge according to claim 1, further comprising:
a liquid inlet flow channel formed in at least one of the plurality of pump wheels; and
a drainage chamber inside the pump body, wherein a first end of the liquid inlet flow channel is connected to the suction port, and the other end is connected to the drainage chamber.

3. The horizontal screw centrifuge according to claim 2, wherein the liquid inlet channel is arcuate.

4. The horizontal screw centrifuge according to claim 1, wherein the drive assembly further comprises:
a small gear fixedly connected to an axle;
a large gear fixedly connected to the feed pipe;
wherein rotation of the large gear causes the small gear to rotate, thereby causing the pump wheel to rotate.

5. The horizontal screw centrifuge according to claim 1, further comprising:
a drainage channel between the pump body and the feed pipe, the drainage channel further connected to a liquid outlet.

6. The horizontal screw centrifuge according to claim 5, wherein a first end of the rotating bowl includes a large endcap and a second end of the rotating bowl includes a small endcap, wherein the centripetal pump assembly is installed at the large endcap and a slag outlet is provided at the small endcap.

7. The horizontal screw centrifuge according to claim 1, wherein the number of the plurality of pump wheels is two or more.

8. The horizontal screw centrifuge according to claim 2, wherein the inner diameter of the liquid inlet channel adjacent to the feed tube gradually increases.

9. The horizontal screw centrifuge according to claim 1, wherein each of the plurality of pump wheels has a circular cross-section, with an arc-shaped transition surface on an upper side.

10. The horizontal screw centrifuge according to claim 4, wherein the driving device further comprises a driving part for driving the feed tube to rotate.

11. A centripetal pump assembly for a horizontal decanter centrifuge having a rotary bowl and a feed pipe, the centripetal pump assembly comprising:
a pump body configured for stationary mounting within the rotary bowl, the pump body defining a discharge chamber;
a plurality of pump wheels, each pump wheel defining a suction port and an internal liquid inlet flow channel extending from the suction port to the discharge chamber, each pump wheel being rotatably mounted within the pump body on a respective wheel shaft; and
a drive assembly configured to simultaneously rotate the plurality of pump wheels to change radial positions of the respective suction ports, thereby adjusting a liquid pool depth within the rotary bowl.

12. The centripetal pump assembly of claim 11, wherein the drive assembly comprises a large gear configured for fixed connection to the feed pipe and a plurality of small gears fixedly connected to respective wheel shafts, the large gear being in meshing engagement with the plurality of small gears.

13. The centripetal pump assembly of claim 11, wherein the liquid inlet flow channel of each pump wheel is arcuate, and wherein an inner diameter of the liquid inlet flow channel gradually increases in a direction from the suction port toward the discharge chamber.

14. The centripetal pump assembly of claim 11, wherein each pump wheel is eccentrically mounted on the respective wheel shaft such that rotation of the pump wheel about the wheel shaft changes the radial position of the suction port.

15. The centripetal pump assembly of claim 11, wherein the plurality of pump wheels comprises two or more pump wheels distributed circumferentially about the pump body.

16. A method of adjusting a liquid pool depth in a horizontal decanter centrifuge during operation, the centrifuge comprising a rotary bowl, a feed pipe, and a centripetal pump assembly having a stationary pump body and a plurality of pump wheels each defining a suction port, the method comprising:
operating the centrifuge at a first liquid pool depth with the suction ports of the plurality of pump wheels positioned at a first radial position within the rotary bowl; and
rotating the plurality of pump wheels simultaneously via a drive assembly to change the radial positions of the suction ports from the first radial position to a second radial position, thereby adjusting the liquid pool depth from the first liquid pool depth to a second liquid pool depth, without interrupting operation of the centrifuge.

17. The method of claim 16, wherein rotating the plurality of pump wheels comprises rotating the feed pipe, the feed pipe being mechanically coupled to the plurality of pump wheels through a gear train comprising a large gear fixedly connected to the feed pipe and a plurality of small gears fixedly connected to respective wheel shafts of the pump wheels.

18. The method of claim 16, further comprising:
monitoring a property of a liquid discharge from the centrifuge, and
automatically adjusting the radial positions of the suction ports in response to changes in the monitored property.
